(19) United States
(12) Patent Application Publication
(10) Pub. No.: US 2010/0331158 A1
(43) Pub. Date: Dec. 30, 2010

(54) Method and Apparatus For Applying Closures To Pouches

(75) Inventors: Scott R. Grasse, Hortonville, WI (US); Daniel J. Moran, Appleton, WI (US)

Correspondence Address: GEORGE R CORRIGAN, 5 BRIARCLIFF COURT, APPLETON, WI, 54915, US

(73) Assignee: CMD Corporation, Appleton, WI (US)

(21) Appl. No.: 12/495,368

(22) Filed: Jun. 30, 2009

(51) Int. Cl. B31B 1/90

(52) U.S. Cl. 493/213; 493/215; 53/133.4; 53/65

(57) ABSTRACT

A method and machine for applying a closure to a series of pouches includes a conveyor extending at least partially through the machine, first and second (optional) infeed modules, a culling module (optional), a replacement infeed module (optional) and a closure module (optional). The infeed modules feed pouches to the conveyor. The culling module includes a sensor that senses an undesired pouch in the series of pouches, and a rejection module that culls the undesired pouch in response thereto. The replacement infeed module feeds a replacement pouch into the gap left by the undesired pouch. The conveyor may be at least partially an intermittent conveyor. The infeed modules may be in a plane with the conveyor. The closure module may be a recloseable closure module, a zipper closure module or a slider closure module. The culling module may be part of each infeed module, and/or distributed over several locations.

### FIELD OF THE INVENTION

The present invention relates generally to the art of pouch making. More specifically, it relates to a pouch having a closure secured thereto.

### BACKGROUND OF THE INVENTION

Flexible pouches with a closure attached thereto are fairly common. Many pouches have recloseable closures, such as zippers or sliders. Recloseable pouches have a wide variety of uses, including holding solids, liquids, being airtight, etc. Examples of articles and products that are enclosed in such pouches include food, juices, medicine, cosmetics, toys, household items, lawn and garden items, and many other items.

Pouches with closures have typically been constructed by either first manufacturing a pouch, and then later applying the closure to the pouch (on a separate machine), or by manufacturing the pouch and applying the closure in-line on a single integrated machine. Both prior art methods have deficiencies.

Using a separate machine to apply the closure can be cumbersome and limits the pouches from being manufactured at high speeds. Each formed pouch must be fed into the machine that places the closure on the pouch. Feeding pouches is often a slow process and can limit the overall machine speed or throughput. Some prior art systems require the pouches to be fed one-by one by the machine operator. Also, if the pouch is fed incorrectly the pouch will be ruined when the closure is affixed to the pouch, or the entire machine is stopped to remove the improperly made/placed pouch.

Using an integrated machine makes it difficult to apply a closure that extends outward from the top end of the finished pouch. This makes it difficult for the ultimate consumer to locate and use the closure. Also, because an integrated machine by definition has many more unit operations in series, the probability of the overall process stopping due to any process upset at any of the individual unit operations is considerably higher. Additionally, existing pouch machines cannot be readily modified to include an in-line closure module.

Accordingly, there exists a need for a method and machine that can apply a closure to a pouch. Preferably it can work with or be retrofitted to existing pouch machines, and can allow for removal of undesired pouches, while still operating at satisfactory speeds.

### SUMMARY OF THE PRESENT INVENTION

According to a first aspect of the invention a machine for applying a closure to a series of pouches includes a conveyor that convey pouches in a machine direction, and at least partially through the machine, a first infeed module, a culling module, a replacement infeed module and a closure module. The first infeed modules feeds pouches to the conveyor, and the conveyor conveys them to the culling module. The culling module includes a culling sensor that senses an undesired pouch in the series of pouches, and includes a rejection module that culls the undesired pouch in response to the sensing. The replacement infeed module is along the conveyor, downstream of the first infeed module, and feeds a replacement pouch into the gap where the undesired pouch had been. The closure module is downstream of the replacement infeed module.

According to a second aspect of the invention a machine for applying a closure to a series of pouches includes a conveyor, a first infeed module, and a second infeed module. The conveyor convey pouches at least partially through the machine. The first and second infeed modules are disposed to feed pouches to the conveyor. In various embodiments the machine includes a culling module, a replacement module, and/or a closure module.

According to a third aspect of the invention a method of applying a closure to a series of pouches includes feeding pouches from a first location to a conveyor and monitoring the series of pouches on the conveyor to determine if one of the series of pouches is undesired. If one is undesired, then the undesired pouch is culled from the series of pouches. A replacement pouch is fed to the conveyor in the gap where the undesired pouch had been. A closure is applied to the series of pouches. Pouches are fed from a second location to the conveyor prior to culling in one embodiment.

According to a fourth aspect of the invention a method of applying a closure to a series of pouches includes feeding pouches from a first location and a second location. The pouches are conveyed from the first location and the second location and the pouches are monitored to determine if one of the pouches is undesired. If a pouch is undesired then culling the undesired pouch from the series of pouches and applying a closure to the series of pouches. A replacement pouch is fed to the conveyor in the gap where the culled pouch had been in one embodiment.

The conveyor is at least partially an intermittent conveyor in one embodiment.

A second infeed module is disposed along the conveyor downstream of the first infeed module, and upstream direction of the culling module in another embodiment.

The infeed modules are in a plane with the conveyor in other embodiments.

The closure module is a recloseable closure module, a zipper closure module or a slider closure module in various embodiments.

According to other embodiments the culling module is part of each infeed module, and/or distributed over several locations.

Other principal features and advantages of the invention will become apparent to those skilled in the art upon review of the following drawings, the detailed description and the appended claims.

### BRIEF DESCRIPTION OF THE DRAWINGS

FIG. 1 is block diagram of one embodiment of the present invention;

FIG. 2 is a schematic diagram of a machine 100 in accordance with one embodiment of the present invention;

FIG. 3 is a sensor in accordance with one embodiment of the present invention;

FIG. 4 is a rejection module in accordance with one embodiment of the present invention;

FIG. 5 is a schematic diagram of a machine 100 in accordance with another embodiment of the present invention;

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular machine and particular steps, it should be understood at the outset that the invention of can also be implemented with other machines and steps. The invention generally includes a stand alone machine to apply a closure, preferably a recloseable closure, to a pouch. The machine can work with pouches made on existing pouch machines, such as the CMD 600SUP or CMD 1067SUP Stand-Up Pouch Machines. However, the invention can be used with any pouches made on any machines.

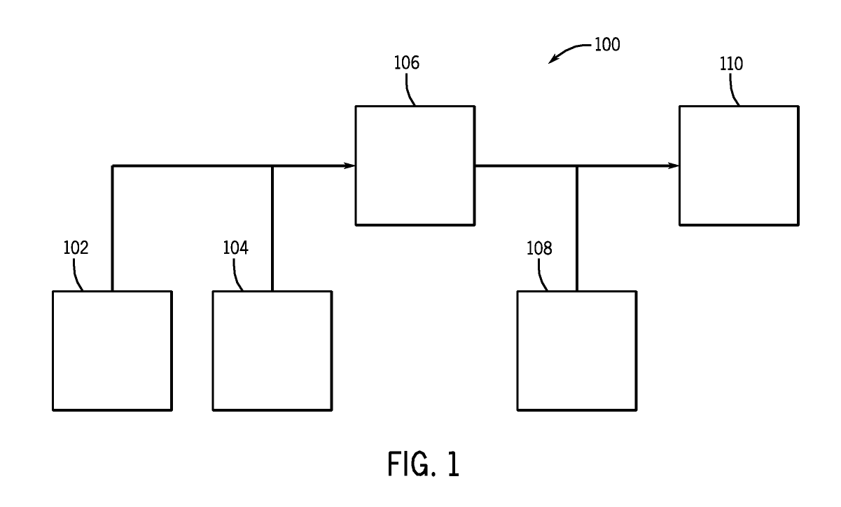

A closure machine 100 that applies closures to pouches is shown as a block diagram in FIG. 1, and includes a first infeed module 102, a second infeed module 104, a culling module 106, a replacement infeed module 108 and a closure module 110. The arrows between modules represent a conveyor that conveys the pouches from one module to the next.

An infeed module is a module that feeds pouches into the machine. A culling module is a module that detects and removes undesired pouches, such as malformed pouches or pouches improperly being conveyed. A replacement infeed module is an infeed module that feeds a pouch into the series so as to replace a pouch that had been culled. A closure module is a module that applies a closure to a pouch. A replacement pouch is a pouch inserted into the series of pouches to take the place of a culled pouch.

A module is a portion of the machine that cooperates to perform one or more functions. A module can be in a single location, or can be distributed or several locations, and can include its own controller, or can be controlled by other modules and/or a separate controller. A closure is a device, such as a zipper, slider, etc, that may be used to close a pouch, and includes recloseable and non-recloseable closures.

Closure machine 100 includes two parallel infeed modules 102 and 104 that alternately feed pouches to the conveyor, so that pouches can be fed more quickly than by a single infeed, and machine 100 can operate at a higher speed or throughput. Infeed modules 102 and 104 are described below, but the invention contemplates that any infeed could be used. One alternative embodiment provides for only one infeed (before culling module) 106, and other embodiments include more than two infeed modules (before culling module 106), and/or not alternating feeding pouches from the multiple infeeds.

Infeed modules 102 and 104 are controlled to cooperate to feed a series of pouches to the conveyor, and the series of pouches subsequently have closures affixed thereto. A series of pouches is a number of pouches coming one after another in sequence or succession. Infeed modules 102 and 104 are described as parallel because they feed pouches to a common conveyor. Their physical position may be parallel or not parallel. The conveyor is also controlled to move intermittently between the feeding of each pouch. Because there are multiple infeed modules, one may be moving the pouch to the conveyor, while the other is dropping the pouch into position. Thus, the number of infeed modules may be determined based on the speed or throughput of the infeed modules and the desired machine speed or throughput.

The conveyor conveys the fed series of pouches to culling module 106, which preferably includes a culling sensor and a rejection module (described below). A culling sensor is a sensor that detects an undesired pouch, such as malformed pouches or pouches improperly being conveyed (i.e., not in the proper location on the conveyor). A rejection module is a module that removes a pouch from the series of pouches being conveyed through the machine. Culling module 106 allows infeed modules 102 and 104 to operate at a higher throughput because improperly fed pouches will be culled from the series. Culled pouches can be recycled if improperly made, and reused if improperly aligned. Culling module 106 is omitted in one embodiment.

The conveyor then conveys the series of pouches to replacement infeed module 108. Replacement infeed module 108 is controlled to feed a replacement pouch into the series of pouches when culling module 106 culls a pouch. The replacement pouch is fed into the series position that had been occupied by the culled pouch. Thus, there is no gap in the series of pouches as the pouches are conveyed through machine 100 to closure module 110. This allows the machine to have an even greater throughput. The series position of a pouch is the position in a series of a pouch position relative to other pouches in the series. As the pouches are conveyed through the machine, the series position remains unchanged (unless the order of the pouches is altered). Replacement infeed module 108 is omitted in an alternative embodiment.

Closure module 110 maybe any module that applies a closure to the series of pouches, and the preferred embodiment is described below. Closure module 110 is preferable a recloseable closure module, and more preferably a zipper closure module, or a slider closure module. A recloseable closure module is a module that applies a recloseable closure to a pouch. A zipper module is a module that applies a zipper to a pouch

The conveyor is a belt, rope, etc, or groups of belts, ropes etc, that act to convey a pouch through the machine. It can include a plurality of sub-conveyors, that each convey pouches through a portion of the machine, and together act to carry the pouches through the multiple portions of the machine, or the entire machine. One embodiment uses sub-conveyors, where the conveyors through a portion of the machine, such as the infeed modules are continuous motion, and the conveyors through another portion, such as the closure module, are intermittent. The preferred embodiment provides that the conveyor is a porous belt over a vacuum plenum. The belt is disposed in the middle of the pouch path, and the vacuum through the belt holds the pouches to the belt. The belt moves pouches from an upstream direction to a downstream direction through machine 100. The conveyor is preferably an intermittent conveyor and machine 100 is an intermittent machine. A first module is downstream of a second module when pouches are conveyed from the second to the first module. A first module is upstream of a second module when pouches are conveyed from the first to the second module. An intermittent conveyor is a conveyor that intermittently conveys pouches.

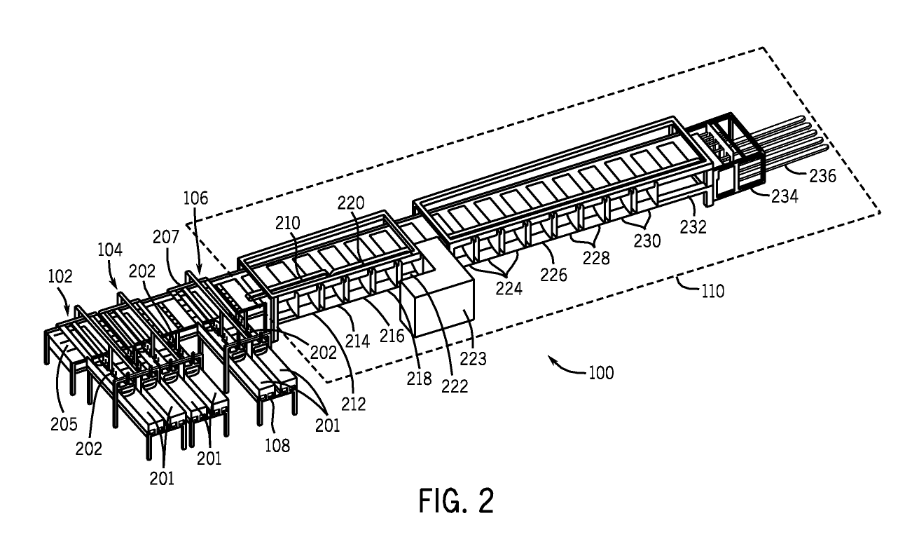

Referring now to FIG. 2, infeed modules 102 and 104 are seen on a schematic of machine 100. Infeed modules 102 and 104 are preferably identical infeed modules, and include two hoppers 201 in which pouches to be fed are stored. The hoppers are preferably capable of holding 25-30 or more pouches. The pouches may be placed in the hopper by hand, or be placed in the hopper automatically. A vacuum cup 202 assembly is moved over one of the hoppers, extend down to the top pouch, and picks up the top pouch. Then, vacuum cup assembly 202 moves the pouch onto a conveyor 205 using a linear actuator, screw drive, servo, etc. The other hopper in each infeed module (i.e., the hopper not used to feed pouches) is preferably used to stage stacks of pouches. Alternatives include using one or more than two hoppers per infeed module. The preferred range of speeds is 25-30 bags fed per minute from both infeed modules, or 12-15 per minute per infeed module.

Infeed modules 102 and 104 are disposed along the conveyor, preferably in the same plane as the conveyor. Disposed along the conveyor means to be disposed to provide pouches to and/or receive pouches form the conveyor. A module and the conveyor are in the same plane when the pouch lies in the same plane in the module as it does when being conveyed by the conveyor.

One alternative provides for indexing the hopper upward based on weight, a photo eye, etc., so that the top pouch is always in an expected location. Another alternative uses a vacuum belt pick-up and a drop with a roller screw for height positioning.

Conveyor 205 advances the series of pouches downstream to culling module 106. Conveyor 205 may be the conveyor described above, and/or may have pins used to maintain the desired spacing and squareness of the series of pouches as they are being conveyed. Culling module 106 may be located between infeed module 104 and replacement module 108, or integrated into each infeed module (it is not shown on FIG. 2, but is shown on FIG. 1 and FIGS. 3 and 4).

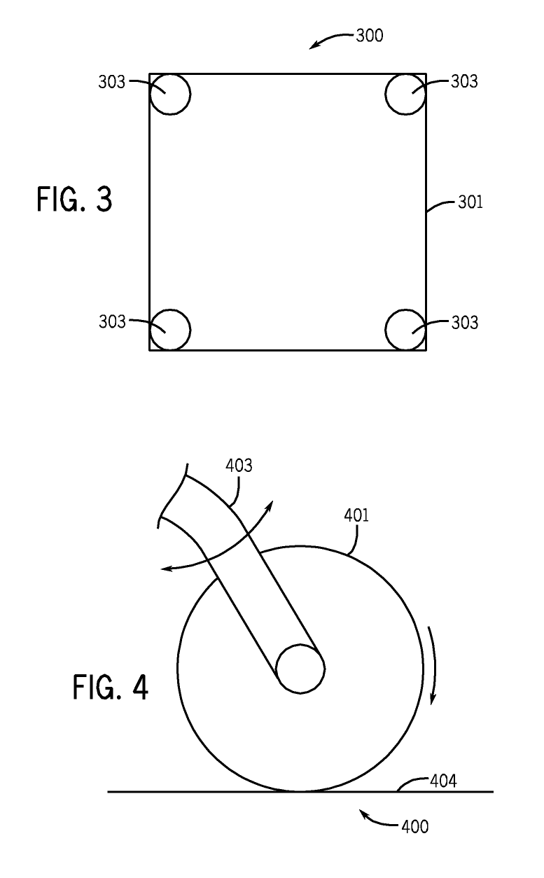

Culling module 106 includes a sensor that preferably detects the misaligned pouches (not positioned properly on the conveyor) and misformed pouches. Alternative embodiments prove for detecting only one or the other of misformed and misaligned pouches, or for detecting other parameters. Misaligned pouches are detected using a plurality of photo eyes that detect any edge that extends beyond the desired location, or detects missing edges. The detection can be done as the pouches are moving (particularly useful for a continuous motion design), or between movements (particularly useful for a continuous motion design). FIG. 3 shows a culling sensor 300 that includes a frame 301 and a plurality of photo eyes 303 used in an intermittent motion machine. Frame 301 is disposed above the conveyor so that a properly positioned pouch will rest directly under frame 301. Frame 301 can be adjustable in size to accommodate different size pouches. Each corner has one of the photo eyes 303 mounted thereon, because a misaligned pouch will have at least one corner out of position (and thus not be sensed). Missing pouches are also detected because all four photo eyes will sense a missing corner.

Misformed pouches are detected by sensed by measuring the thickness (number of layers) of the pouch at one or more locations on the pouch, for example by using a spring loaded in-process micrometer. If the pouch is not the correct thickness, then it was not properly formed. Also, double feeds will be detected as being too thick, and missing pouches will be detected as too thin. Improperly aligned pouches may also be detected by the thickness sensor (because the sensed number of layers at a given location will not be the number expected). Thickness is preferably sensed at the location where the alignment is sensed. A controller monitors the signals from photo eyes 303 and from the micrometer.

When the signal from sensor 300 indicates a pouch is misaligned or misformed, the controller sends a signal to a rejection module. The pouch is then rejected or culled by the rejection module. The rejection is preferably preformed by lowering a rotating kick-roller into contact with the pouch. The rotating kick-roller kicks the pouch off the side of the conveyor for recycling (for misformed pouches) or for restacking (for misaligned pouches) in an infeed hopper. A rejection module 400 is shown in FIG. 4 and includes a rotating roller 401 mounted on an arm 403. Arm 403 is moved down when an undesired pouch 404 is sensed, so that roller 401 comes into contact with pouch 404. Ann 403 is raised and roller 403 not in contact with a pouch in the normal position. Other rejection modules include vacuum cups, a vacuum belt, pins, etc. Rejection module 400 is preferably located at the same location as culling sensor 300. Alternatives include integrating culling module 106 into each infeed module, or having one culling module located after each infeed module. When integrated with the infeed module, frame 301 and rejection module 400 are placed directly over conveyor 205 where infeed modules 102 and 104 drop the pouches they feed.

Replacement infeed module 108 is preferably identical to infeed modules 102 and 104 (although controlled differently). It may also include a culling module. Replacement module 108 also receives a signal when an undesired pouch was sensed, and in response feeds a pouch into the series position where a pouch had been culled. Thus, there are not gaps in the series of pouches, even when a pouch is culled. A single replacement infeed module is preferred, because it is not needed to feed as frequently as infeed modules 102 and 104. However, if needed, such as when operating at very high machine speeds or throughputs or when infeed modules 102 and 104 are operating at the high end of their speed or throughput range and more likely to misalign pouches, multiple replacement infeed modules can be used.

Conveyor 205 then conveys the series of pouches to closure module 110. Any design of closure module 110 may be used with the invention. The particular sequence of operations performed to apply the closure and seal the pouch as needed, as well as the type of closure applied, is not particularly important to this invention. The preferred embodiment is shown on FIG. 2 and includes a gap setting belt 210, a registration eye and creaser 212, a long seal die cut 214, a top/bottom fold back 216, a registration eye and gusset cut 218, a second belt 220, and a bottom fold back 222. Also included are a zipper insertion/tack seal station 223 and three zipper seals stations 224, which together form a zipper module, a top fold back 226, two top seals 228, two cool bars 230, and an open space 232 which could be used for repeating previous operations. When the closures have been applied to the pouches the pouches are stacked in a stacker 234 and the stacks of pouches are provided on an outfeed conveyor 236. Each of these stations and operations may be consistent with the prior art.

Preferably a single conveyor is used to move the pouches through closure module 210, although a series of conveyors could be used. In operation the conveyor is advanced, moving a new pouch to each station. Then, each station performs its operation. the conveyor is advanced, and the process repeats. Thus, when the pouch reaches the end of closure module 210, it has had each operation preformed on it, and is a complete pouch with a closure.

Alternatives include using commercially available closure modules, using fewer or more stations, and/or replacing zipper seals stations 224 with slider stations, recloseable seal stations, or nonrecloseable seal stations to form a slider module, recloseable seal module and nonrecloseable seal module, respectively. Another alternative includes using the following stations: an optional registration eye station, an optional metering nip to accelerate pouches to obtain a specific gap between pouches, a gusset edge punch and lip separator station, skis or fingers which open top and bottom bag lips to expose the gussets, a gusset chopper station such as a guillotine knife, zero clearance punch, rotary slitter or moving razor blades, a zipper insertion and tack seal station, a full bag face length seal station, a facelength seal between gussets only station, another full bag facelength seal station, a seal gusset ends only station, a fold top lip down station, a seal gusset ends only (through all layers) station, another seal gusset ends only (through all layers) station, a seal cooler station, an optional seal cooler station (for thicker materials), an optional station to clean-up punches (in the event of misaligned edges from original punches), an eject nip, and a stacker conveyor to provide shingled or stacked product for manual offload. Again, this embodiment may be modified to provide additional or fewer operations as needed.

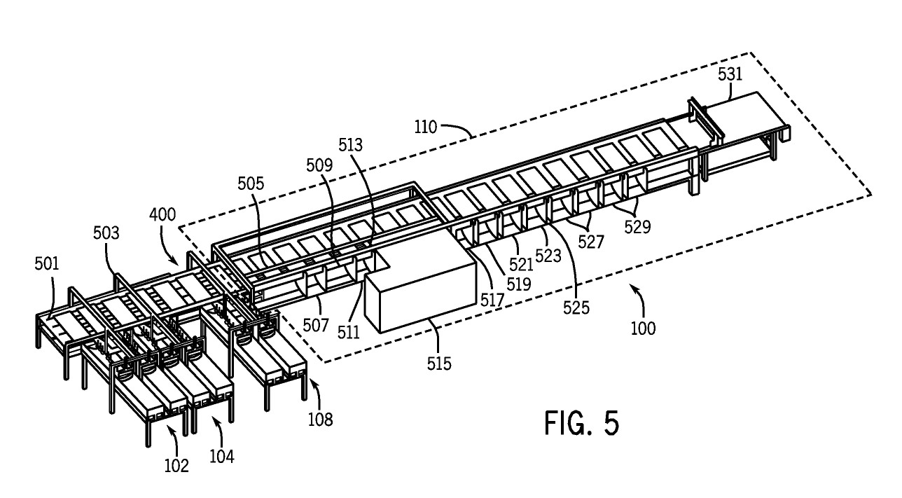

Another embodiment of machine 100 is shown in FIG. 5. A continuous motion pin chain conveyor 501 conveys pouches from infeed modules 102 and 104 to rejection module 400. A sensor 503 is located immediately after infeed module 104, and culling module 106 is distributed among several locations (after infeed module 104 and aligned with replacement infeed module 108). The infeed module 102, 104 and 108, and culling module 106 operate as described above, and pouches are conveyed to closure module 110.

Closure module 110 includes a top belt 505, a zero clearance punch station 507, top and bottom fold backs 509, gusset trim station 511, bottom fold up station 513, zipper inserter and tack/seal station 515 (which is a slider or other closure inserter in other embodiments), full length seal station 517, seal between gussets station 519, another full length seal station 521, an end seal station 523, a fold top down station 525, a pair of top end seal stations 527, a pair of cool bars 529 and a stacking conveyor 531.

The invention includes a method of applying closures to a series of pouches, and includes feeding pouches from one or more infeed modules, culling improperly aligned or improperly formed pouches, replacing the culled pouches, and applying a closure, and can be preformed using the equipment described above, or other equipment. The culling can be omitted, or the culling can be performed at each infeed module.

Numerous modifications may be made to the present invention which still fall within the intended scope hereof. Thus, it should be apparent that there has been provided in accordance with the present invention a method and apparatus for applying closures to pouches that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A machine for applying a closure to a series of pouches, comprising:
a conveyor, disposed to convey pouches in a machine direction at least partially through the machine;
a first infeed module disposed to feed pouches to the conveyor;
a culling module, disposed along the conveyor, and including a culling sensor disposed to sense an undesired pouch in the series of pouches, and further including a rejection module disposed to cull the undesired pouch in response to the sensing;
a replacement infeed module, disposed along the conveyor in the downstream direction of the first infeed module, and disposed to feed a replacement pouch into the series in a series position that had been occupied by the undesired pouch; and
a closure module disposed in the downstream direction of replacement infeed module.

2. The machine of claim 1, wherein the conveyor is at least partially an intermittent conveyor.

3. The machine of claim 1, further comprising, a second infeed module, disposed along the conveyor in the downstream direction of the first infeed module, and in an upstream direction of the culling module.

4. The machine of claim 3, wherein at least one of the first infeed module, the second infeed module, and the replacement infeed module are in a plane with the conveyor.

5. The machine of claim 1, wherein the closure module is a recloseable closure module.

6. The machine of claim 1, wherein the closure module is a zipper module.

7. A machine for applying a closure to a series of pouches, comprising:
a conveyor, disposed to convey pouches in a machine direction at least partially through the machine;
a first infeed module disposed to feed pouches to the conveyor;
a second infeed module disposed to feed pouches to the conveyor; and
a closure module located, wherein the conveyor conveys the pouches to the closure module.

8. The machine of claim 7, wherein the conveyor is at least partially an intermittent conveyor.

9. The machine of claim 8, further comprising a culling module, disposed along the conveyor in a downstream direction of the first infeed module and the second infeed module, wherein the culling module comprises a culling sensor disposed to sense an undesired pouch in the series of pouches and a rejection module disposed to cull the undesired pouch in response to the sensing.

10. The machine of claim 9, further comprising, a replacement infeed module, disposed along the conveyor in the downstream direction of the culling module, to disposed feed a replacement pouch into the series in a series position that had been occupied by the undesired pouch.

11. The machine of claim 10, wherein at least one of the first infeed module, the second infeed module, and the replacement infeed module are in a plane with the conveyor.

12. The machine of claim 10, wherein the closure module is a recloseable closure module.

13. The machine of claim 12, wherein the closure module is a zipper module.

14. A method of applying a closure to a series of pouches, comprising:
feeding pouches from a first location to a conveyor;
monitoring the series of pouches on the conveyor to determine if one of the series of pouches is undesired;
culling an undesired pouch from the series of pouches;
feeding a replacement pouch to the conveyor into the series of pouches, wherein the replacement pouch is fed into a series position that had been occupied by the undesired pouch; and
applying a closure to the series of pouches.

15. The method of claim 14, further comprising feeding pouches from a second location to the conveyor prior to culling, wherein the series of pouches is formed by the pouches from the first location and the second location.

16. The method of claim 15, wherein applying includes applying a recloseable closure to the series of pouches.

17. The method of claim 15, wherein applying includes applying a zipper to the series of pouches.

18. The method of claim 16, wherein the conveyor is at least partially intermittently moved.

19. The method of claim 18, wherein feeding pouches from a first location comprises moving pouches within a single plane.

20. A method of applying a closure to a series of pouches, comprising:
feeding pouches from a first location;
feeding pouches from a second location;
conveying pouches as the series of pouches from the first location and the second location;
monitoring the series of pouches on the conveyor to determine if one of the series of pouches is undesired;
culling an undesired pouch from the series of pouches; and
applying a closure to the series of pouches.

21. The method of claim 20, wherein applying includes applying a recloseable closure to the series of pouches.

22. The method of claim 20, wherein applying includes applying a zipper to the series of pouches.

23. The method of claim 22, further comprising feeding a replacement pouch to the conveyor into the series of pouches, wherein the replacement pouch is fed into a series position that had been occupied by the undesired pouch.

24. The method of claim 23, wherein conveying includes at least partially intermittently conveying.

25. The method of claim 23, wherein feeding pouches from a first location comprises moving pouches within a single plane.

26. A machine for applying a closure to a series of pouches, comprising:
means for feeding pouches from a first location to a conveyor;
means for monitoring the series of pouches on the conveyor to determine if one of the series of pouches is undesired;
means for culling an undesired pouch from the series of pouches;
means for feeding a replacement pouch to the conveyor into the series of pouches, wherein the replacement pouch is fed into a series position that had been occupied by the undesired pouch; and
means for applying a closure to the series of pouches.

27. The machine of claim 26, further comprising means for feeding pouches from a second location to the conveyor prior to culling, wherein the series of pouches is formed by the pouches from the first location and the second location.

28. The machine of claim 27, wherein the means for applying includes a means for applying a recloseable closure to the series of pouches.

29. The machine of claim 27, wherein the means for applying includes a means for applying a zipper to the series of pouches.

30. The machine of claim 28, further comprising means for at least partially intermittently moving the conveyor.

31. A machine for applying a closure to a series of pouches, comprising:
means for feeding pouches from a first location;
means for feeding pouches from a second location;
means for conveying pouches as the series of pouches from the first location and the second location;
means for monitoring the series of pouches on the means for conveying to determine if one of the series of pouches is undesired;
means for culling an undesired pouch from the series of pouches; and
means for applying a closure to the series of pouches.

32. The machine of claim 31, wherein the means for applying includes a means for applying a recloseable closure to the series of pouches.

33. The machine of claim 32, wherein the means for applying includes a means for applying a zipper to the series of pouches.

34. The machine of claim 32, further comprising means for feeding a replacement pouch to the means for conveying into the series of pouches, wherein the replacement pouch is fed into a series position that had been occupied by the undesired pouch.

35. The machine for claim 34, wherein the means for conveying includes means for at least partially intermittently conveying.
